(19) United States
(12) Patent Application Publication
(10) Pub. No.: US 2025/0229367 A1
(43) Pub. Date: Jul. 17, 2025

(54) DOUBLE-TRACK WELDING SYSTEM

(71) Applicant: CHENGDU XIONGGU JIASHI ELECTRICAL CO, LTD, Chengdu, Sichuan (CN)

(72) Inventors: Biqing LIU, Chengdu, Sichuan (CN); Rongdong LI, Chengdu, Sichuan (CN); Jianglong HE, Chengdu, Sichuan (CN); Wang ZHANG, Chengdu, Sichuan (CN); Tan SHU, Chengdu, Sichuan (CN); Youjin XIAO, Chengdu, Sichuan (CN); Zonglei YU, Chengdu, Sichuan (CN); Bin CHEN, Chengdu, Sichuan (CN); Chao HE, Chengdu, Sichuan (CN); Zhao WEI, Chengdu, Sichuan (CN); Miao MA, Chengdu, Sichuan (CN); Zejun XIAN, Chengdu, Sichuan (CN); Xiaosheng QIN, Chengdu, Sichuan (CN)

(73) Assignee: CHENGDU XIONGGU JIASHI ELECTRICAL CO, LTD, Chengdu, Sichuan (CN)

(21) Appl. No.: 18/730,757

(22) PCT Filed: Aug. 31, 2022
(86) PCT No.: PCT/CN2022/116128

§ 371 Date: Jul. 20, 2024

(30) Foreign Application Priority Data
Jan. 20, 2022 (CN) 202210065378.4

(51) Int. Cl. B23K 37/02; B23K 9/028; F16L 13/02; F16L 55/18

(52) U.S. Cl. CPC B23K 37/0217; B23K 9/0286; B23K 37/0276; F16L 13/02; F16L 55/18

(57) ABSTRACT

A double-track welding system is provided. A first track is detachably mounted on a first side of a weld seam of a workpiece, and a second track is detachably mounted on a second side of the weld seam of the workpiece. The first track and the second track are both mounted on a fixed support, and the fixed support can drive the first track and second track to move. At least one welding trolley is arranged on each of the first track and the second track. An image acquisition component is used for acquiring an image of a part to be welded; a weld seam scanning device is used for acquiring the weld seam morphology; and a control system is used for controlling, according to the image of the part to be welded, the fixed support to move.

This disclosure claims the benefit of the priority to Chinese Patent Disclosure No. 202210065378.4, titled “DOUBLE-TRACK WELDING SYSTEM”, filed with the China National Intellectual Property Administration on Jan. 20, 2022, which is incorporated herein by reference in its entirety.

### FIELD

The present disclosure relates to the technical field of pipeline welding equipment, and in particular to a double track welding system.

### BACKGROUND

With the peak period of construction of long-distance oil and natural gas pipelines and the arrival of the era of intelligent welding of long-distance pipelines, the transformation and upgrading to pipeline welding systems is very important.

In the conventional technology, regarding the welding to long-distance pipelines, the applied procedures include: opening a groove; welding the root of the groove; hot welding the groove; carrying out three times of filling welding on the groove; performing cover welding on the surface layer of the welding seam. In the conventional technology, each process takes a long time, and the welding efficiency is further reduced if each process needs to be heated.

In addition, in the conventional technology, external welding equipment constructed on site requires manual auxiliary operations during welding. Such as wire cutting before welding, gas testing, railing, heating, fine-tuning during welding, and grinding of upper and lower joints, etc. The requirements for welders are relatively high, the workload is large, and the efficiency is low. Meanwhile, the pre-welding heating and temperature measurement to the pipeline before welding and during the welding process require manual operation, and it is easy to be negligent and inactive, resulting in a decrease in welding quality.

Therefore, how to improve the automation degree of the double track welding system is a technical problem that those skilled in the art need to solve at present.

### SUMMARY

An object according to the present disclosure is to provide a double track welding system, which can effectively improve the welding efficiency and precision thereof, and can realize the automatic operation of the whole welding process.

In order to achieve the above object, the following technical solutions are provided according to the present application.

A double track welding system, including:
a first track, the first track is detachably mounted on a first side of the welding seam of the workpiece;
a second track, the second track is detachably mounted on a second side of the welding seam of the workpiece;
a fixing bracket, the first track and the second track are both mounted on the fixing bracket, and the fixing bracket can drive the first track and the second track to move;
multiple welding trolleys, each of the first track and the second track is provided with at least one the welding trolleys;
an image acquisition component for acquiring image of a part to be welded; a welding seam scanning device for obtaining the shape of the welding seam;
a control system, where the control system is configured to control the movement of the fixing bracket according to the image of the part to be welded; the control system is further configured to determine preset welding process parameters according to the profile of the welding seam, and control the welding trolley to weld the welding seam according to the preset welding process parameters.

In an embodiment, the double track welding system further includes a grinding mechanism, and the grinding mechanism is mounted on the fixing bracket; the control system is configured to control the movement of the fixing bracket according to the image of the part to be welded, so that the grinding mechanism is moved to correspond to the position of the groove to be welded.

In an embodiment, the grinding mechanism includes an image acquisition component and a grinding laser sensor, the image acquisition component is mounted on the fixing bracket, and the grinding laser sensor is mounted on the grinding mechanism; the grinding laser sensor is configured to identify the profile and position of the welding seam; the control system is further used to control the action of the grinding mechanism according to the contour and position of the welding seam; the grinding mechanism includes a grinding frontward and backward adjustment mechanism, a grinding leftward and rightward adjustment mechanism, a grinding upward and downward adjustment mechanism and a grinding assembly, the control system may control the position of the grinding assembly by the grinding frontward and backward adjustment mechanism, the grinding leftward and rightward adjustment mechanism, and the grinding upward and downward adjustment mechanism.

In an embodiment, the double track welding system further includes a leftward and rightward adjustment sliding table, where the leftward and rightward adjustment sliding table includes a sliding part and a fixing part. The sliding part is mounted on the fixing bracket and can drive the fixing bracket to move, and the fixing part is mounted on the workstation; the leftward and rightward adjustment sliding table includes a sliding table sliding block, a sliding table linear sliding rail and a sliding table cylinder; the sliding table sliding block can move along the sliding table linear sliding rail, the sliding table cylinder is mounted on the sliding table sliding block, and the grinding mechanism is mounted on the sliding table cylinder; the control system is further configured for controlling the sliding table sliding block to move according to the position of the welding seam.

In an embodiment, the first track and the second track are both provided with a wire cutting mechanism; the control system is further configured to control the welding trolley to move to the position of the wire cutting mechanism when receiving a wire cutting instruction, and control the wire cutting mechanism to perform a wire cutting action.

In an embodiment, the double track welding system further includes:
a heating device, where the heating device is provided on one of the first track and the second track;
a grounding device, where the grounding device is provided on the other of the first track and the second track;
a temperature collecting device for timely acquiring the temperature of the part to be welded;
the control system is further configured to control the heating device to heat the part to be welded when the temperature of the part to be welded is lower than a preset temperature.

In an embodiment, the heating device is position-adjustably mounted on the first track or the second track; the control system is configured to control the heating device to move to the welding seam for heating, and control the heating device to return back after the heating is completed.

In an embodiment, the first track and the second track both include an upper ring gear, a left ring gear and a right ring gear. The left ring gear and the right ring gear are separable, and a clamping cylinders are provided between the left ring gear and the upper ring gear and between the right ring gear and the upper ring gear, respectively; the control system is further configured to control the extension and retraction of the clamping cylinder to disassemble or clamp the workpiece; both the first track and the second track are provided with tightening cylinders; the control system is configured for controlling the tightening cylinder to tighten the workpiece after the first track and the second track are mounted in place.

In an embodiment, the welding trolley includes a travelling chassis, the composite welding gun, the welding torch and the welding seam scanning device. The image acquisition component further includes a trolley laser sensor, the composite welding gun, the welding torch and the welding seam scanning device are all position-adjustably mounted on the travelling chassis, and the composite welding gun includes a gas shielded welding gun and an argon arc welding gun; the control system is further configured to control the movement of the composite welding gun, the welding torch and the welding seam scanning device.

In an embodiment, the gas shielded welding gun is configured for the MAG welding process, and the argon arc welding gun is configured for the TIG welding process; the composite welding gun is configured to control arc starting in sections by adopting a combination of TIG welding and MAG welding in the arc starting lap region R of each weld pass, and then MAG welding is configured for subsequent welding.

In an embodiment, the welding trolley further includes a welding torch upward and downward adjustment mechanism for adjusting the position of the welding torch, a laser upward and downward adjustment mechanism for adjusting the position of the laser sensor of the trolley, a trolley leftward and rightward adjustment mechanism for adjusting the leftward and rightward positions of the welding trolley, a wire drawing mechanism for feeding welding wire and a temperature measuring mechanism for monitoring the temperature of the workpiece before welding. The control system is linked with the welding torch upward and downward adjustment mechanism, the laser upward and downward adjustment mechanism, the trolley leftward and rightward adjustment mechanism and the temperature measuring mechanism in communication connection.

In an embodiment, the control system executes control operations in sequence after receiving the one-button start instruction.

The double track welding system provided according to the present disclosure includes: a first track, the first track is detachably mounted on a first side of the welding seam of the workpiece; a second track, the second track is detachably mounted on a second side of the welding seam of the workpiece; a fixing bracket, the first track and the second track are both mounted on the fixing bracket, and the fixing bracket can drive the first track and the second track to move; multiple welding trolleys, each of the first track and the second track is provided with at least one the welding trolleys; an image acquisition component for acquiring image of a part to be welded; a welding seam scanning device for obtaining the profile of the welding seam; a control system, where the control system is configured to control the movement of the fixing bracket according to the image of the part to be welded; the control system is further configured to determine preset welding process parameters according to the profile of the welding seam, and control the welding trolley to weld the welding seam according to the preset welding process parameters. The double track welding system provided by the present disclosure can effectively improve the welding efficiency through the arrangement of at least two tracks. Meanwhile, the image of the part to be welded and the profile of the welding seam are collected by the image acquisition component, and then the automatic identification, automatic planning and automatic welding of the welding seam are realized by the control system, which improves the degree of automation, effectively reduces the labor intensity, and improves the welding precision.

In an exemplarily embodiment, the double track welding system further includes: a heating device, which is provided on one of the first track and the second track; a grounding device, which is provided on the other of the first track and the second track; a temperature collecting device for timely acquiring the temperature of the part to be welded; the control system is further configured to control the heating device to heat the part to be welded when the temperature of the part to be welded is lower than a preset temperature. With the above configuration, through the arrangement of the heating device and the temperature collecting device, the workpiece can be automatically heated, and the degree of automation can be further improved.

### BRIEF DESCRIPTION OF THE DRAWINGS

For more clearly illustrating the technical solutions of embodiments of the present disclosure or in the conventional technology, drawings referred to for describing the embodiments or the conventional technology will be briefly described hereinafter. Apparently, the drawings in the following description are only several examples of the present application, and for those skilled in the art, other drawings may be obtained based on these drawings without any creative efforts.

FIG. 1 is a schematic structural diagram of a specific embodiment of a double track welding system provided by the present application;

FIG. 2-1 is a schematic diagram of the structure of the leftward and rightward adjustment sliding table in the double track welding system shown in FIG. 1;

FIG. 2-2 is another perspective of the structure of the leftward and rightward adjustment sliding table in the double track welding system shown in FIG. 1;

FIG. 3-1 is a schematic structural diagram of the grinding mechanism in the double track welding system shown in FIG. 1;

FIG. 3-2 is a schematic structural diagram from another perspective of the grinding mechanism in the double track welding system shown in FIG. 1;

FIG. 3-3 is a schematic diagram of the transition of the grinding mechanism from the grinding working state to the grinding-completed working state in the double track welding system shown in FIG. 1;

FIG. 3-4 is an enlarged schematic diagram of the grinding component in the grinding mechanism shown in FIG. 3-2;

FIG. 3-5 is an enlarged schematic diagram of another perspective of the grinding component in the grinding mechanism shown in FIG. 3-2;

FIG. 4-1 is a schematic structural diagram of the first track in the double track welding system shown in FIG. 1;

FIG. 4-2 is a schematic structural diagram from another perspective of the first track in the double track welding system shown in FIG. 1;

FIG. 4-3 is a schematic structural diagram of the first upper ring gear in the first track shown in FIG. 4-1;

FIG. 4-4 is a schematic structural diagram of the first wire cutting mechanism in the first track shown in FIG. 4-1;

FIG. 4-5 is a schematic structural diagram of the first left ring gear in the first track shown in FIG. 4-1;

FIG. 4-6 is a schematic structural diagram of the first right ring gear in the first track shown in FIG. 4-1;

FIG. 5-1 is a schematic structural diagram of the second track in the double track welding system shown in FIG. 1;

FIG. 5-2 is a schematic structural diagram from another perspective of the second track in the double track welding system shown in FIG. 1;

FIG. 5-3 is a schematic structural diagram of the second upper ring gear in the second track shown in FIG. 5-1;

FIG. 5-4 is a schematic structural diagram of the second wire cutting mechanism in the second track shown in FIG. 5-1;

FIG. 5-5 is a schematic structural diagram of the second left ring gear in the second track shown in FIG. 5-1;

FIG. 5-6 is a schematic structural diagram of the second right ring gear in the second track shown in FIG. 5-1;

FIG. 6-1 is a schematic structural diagram of the welding trolley in the double track welding system shown in FIG. 1;

FIG. 6-2 is a schematic structural diagram from another perspective of the welding trolley in the double track welding system shown in FIG. 1;

FIG. 6-3 is a schematic diagram of an internal structure of the travelling chassis in the welding trolley shown in FIG. 6-1;

FIG. 6-4 is a schematic diagram of an overall structure of the travelling chassis in the welding trolley shown in FIG. 6-1;

FIG. 6-5 is a schematic structural diagram of the welding torch upward and downward adjustment mechanism in the welding trolley shown in FIG. 6-1;

FIG. 6-6 is a schematic structural diagram of the laser upward and downward adjustment mechanism in the welding trolley shown in FIG. 6-1;

FIG. 6-7 is a schematic structural diagram of the wire drawing mechanism in the welding trolley shown in FIG. 6-1;

FIG. 6-8 is a schematic structural diagram of the laser sensor in the welding trolley shown in FIG. 6-1;

FIG. 6-9 is a schematic structural diagram of the welding torch in the welding trolley shown in FIG. 6-1;

FIG. 6-10 is a schematic structural diagram of another perspective of the welding torch in the welding trolley shown in FIG. 6-1;

FIG. 6-11 is a schematic structural diagram of the trolley leftward and rightward adjustment mechanism in the welding trolley shown in FIG. 6-1;

FIG. 6-12 is a schematic structural diagram of the infrared temperature measuring mechanism in the welding trolley shown in FIG. 6-1;

FIG. 6-13 is a schematic structural diagram of the composite welding gun in the welding trolley shown in FIG. 6-1;

FIG. 6-14 is a cross-sectional view of the composite welding gun in the welding trolley shown in FIG. 6-1;

FIG. 6-15 is a schematic diagram of the lap area in the weld bead of the groove;

FIG. 7 is a block diagram of the “one-button operation” system in the double track welding system provided by the present application;

FIG. 8 is a schematic flowchart of the “one-button operation” process in the double track welding system provided by the present application;

FIG. 9 is a control structure diagram of the “one-button operation” system in the double track welding system provided by the present application;

FIG. 10-1 is a schematic flowchart of a welding process parameter planning method in a double track welding system provided by the present application;

FIG. 10-2 is a schematic diagram of the first neural network in the welding process parameter planning method shown in FIG. 10-1; and

FIG. 10-3 is a schematic diagram of the second neural network in the welding process parameter planning method shown in FIG. 10-1.

Reference numerals in the figures: 100 leftward and rightward adjustment sliding table; 101 sliding table motor; 102 sliding table cylinder; 103 sliding table linear sliding rail; 104 sliding table ball screw; 105 sliding table travel switch; 106 sliding table sliding block; 107 sliding table mounting bracket; 200 grinding mechanism; 201 grinding frontward and backward adjustment mechanism; 202 grinding leftward and rightward adjustment mechanism; 203 grinding upward and downward adjustment mechanism; 204 grinding assembly; 205 grinding laser sensor; 206 grinding control system; 207 grinding power; 208 grinding cylinder; 209 image acquisition component; 300 first track; 301 first upper ring gear; 3011 first upper jacking cylinder; 3012 first upward stroke switch; 3013 first upper travelling track; 3014 first upper ring gear body; 302 first left ring gear; 3021 first left jacking cylinder; 3022 first left alignment cylinder; 3023 first left travelling track; 3024 first left ring gear body; 303 first right ring gear; 3031 first right jacking cylinder; 3032 first right ring gear body; 3033 first right clamping cylinder; 3034 first right positioning cylinder; 3035 first right travelling track; 304 grounding device; 305 first wire cutting mechanism; 306 first clamping cylinder; 307 first electromagnetic valve assembly; 400 second track; 401 second upper ring gear; 4011 second upper jacking cylinder; 4012 second upward stroke switch; 4013 second upper travelling track; 4014 second upper ring gear body; 4015 upper heating coil fixing bracket; 4016 upper heating coil push-out cylinder; 402 second left ring gear; 4021 second left jacking cylinder; 4022 second left alignment cylinder; 4023 second left travelling track; 4024 second left ring gear body; 4025 left heating coil mounting bracket; 4026 left heating coil adjustment cylinder; 403 second right ring gear; 4031 second right jacking cylinder; 4032 second right ring gear body; 4033 second right clamping cylinder; 4034 second right positioning cylinder; 4035 second right travelling track; 4036 right heating coil mounting bracket; 4037 right heating coil adjustment cylinder; 404 heating coil; 405 second wire cutting mechanism; 4051 second blade; 4052 second wire cutting cylinder; 4053 second adjustment cylinder; 4054 second ball spline; 406 second clamping cylinder; 407 second electromagnetic valve assembly; 500 welding trolley; 501 travelling chassis; 5011 trolley travelling motor; 5012 trolley driving wheel; 5013 trolley driven wheel; 5014 trolley spring; 5015 trolley handle; 5016 trolley travelling sliding block; 5017 trolley cam; 502 welding torch upward and downward adjustment mechanism; 5021 welding gun motor; 5022 welding gun ball screw; 5023 welding gun ball spline; 5024 welding gun sliding block; 503 laser upward and downward adjustment mechanism; 5031 laser motor; 5032 laser ball screw; 5033 laser ball spline; 5034 laser sliding block; 504 wire drawing mechanism; 5041 wire drawing motor; 5042 wire drawing driving wheel; 5043 wire pressing wheel; 5044 wire drawing adjustment handle; 5045 wire drawing spring; 5046 insulating pad; 505 trolley laser sensor; 5051 laser sensor body; 5052 mounting box body; 5053 laser control line; 5054 slag baffle; 5055 transparent plate; 506 welding torch; 5061 welding gun assembly; 5062 nozzle; 5063 protective cover; 5064 welding torch handle; 5065 copper mesh; 5066 welding torch mounting bracket; 507 trolley leftward and rightward adjustment mechanism; 5071 trolley leftward and rightward adjustment motor; 5072 trolley ball screw; 5073 trolley ball spline; 5074 trolley leftward and rightward adjustment sliding block; 5075 trolley mounting bracket; 508 trolley control system; 509 infrared temperature measuring mechanism; 5091 protective cover; 5092 temperature sensor; 5093 temperature measuring mounting bracket; 5094 infrared control line; 510 composite welding gun; 5101 welding gun cylinder; 5102 gas shielded welding gun; 5103 argon arc welding gun; 5014 welding gun protective cover; 5105 welding gun mounting bracket; 600 workpiece; R arc start overlap area.

### DETAILED DESCRIPTION OF THE EMBODIMENTS

A core of the present disclosure is to provide a double track welding system, which can effectively reduce the labor intensity of the staff and reduce the influence of artificial factor.

Technical solutions in the embodiments of the present disclosure are clearly and completely described hereinafter in conjunction with the drawings in the embodiments of the present application. Apparently, the embodiments described in the following are only some embodiments of the present application, rather than all embodiments. Based on the embodiments in the present application, all of other embodiments, made by the person skilled in the art without any creative efforts, fall into the scope of protection of the present application.

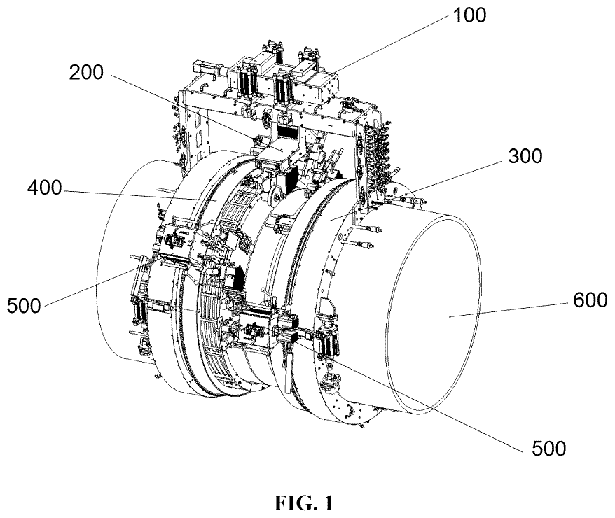

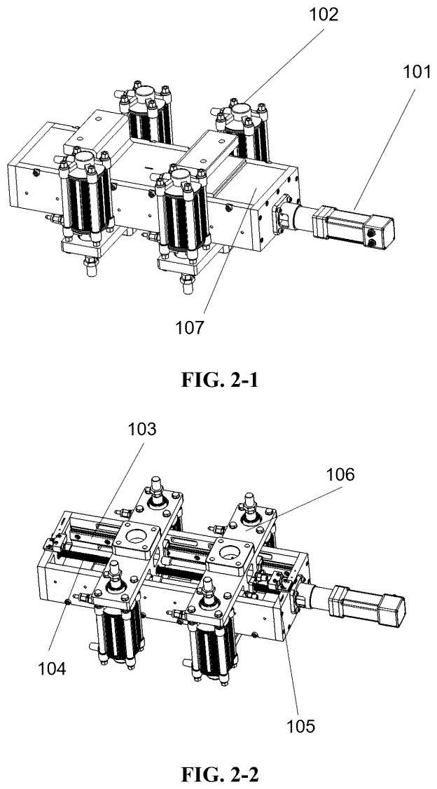

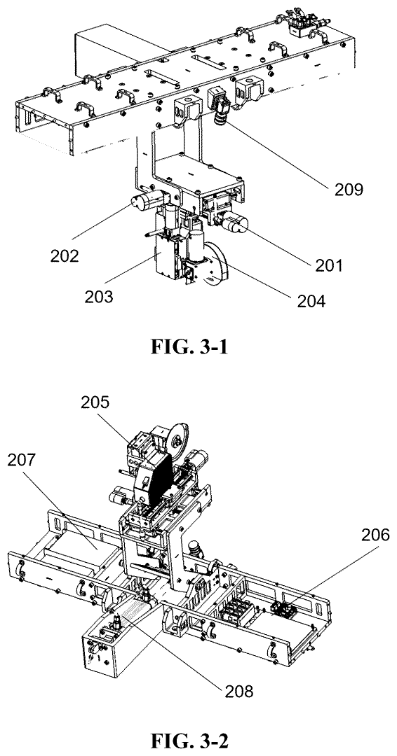

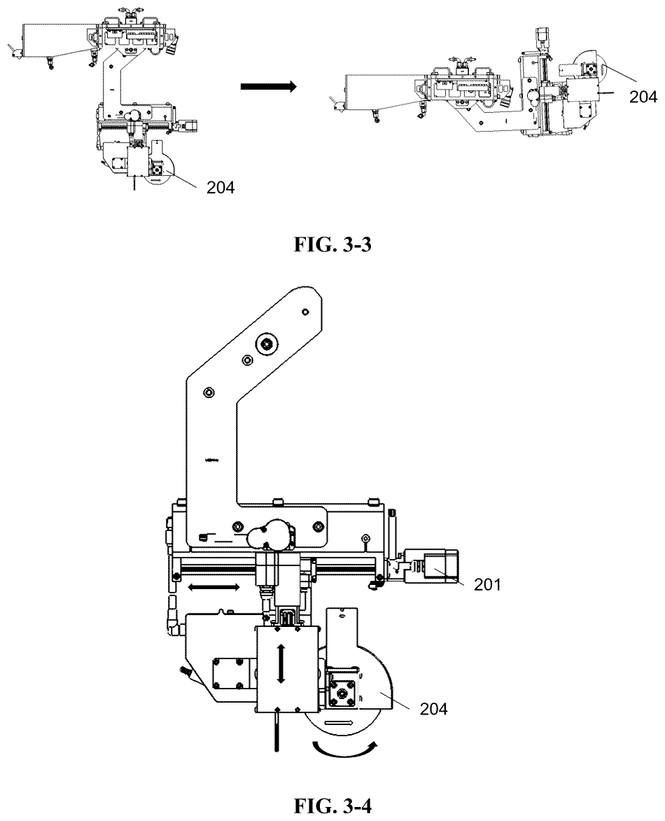

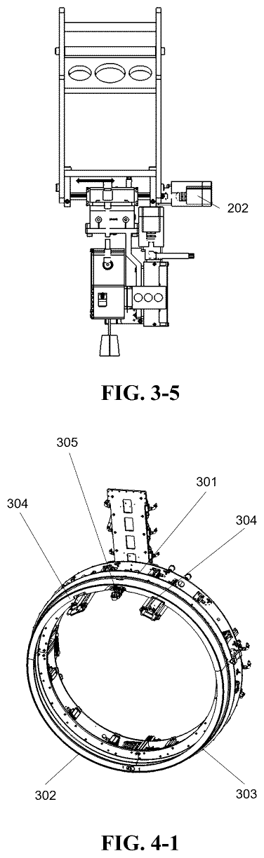

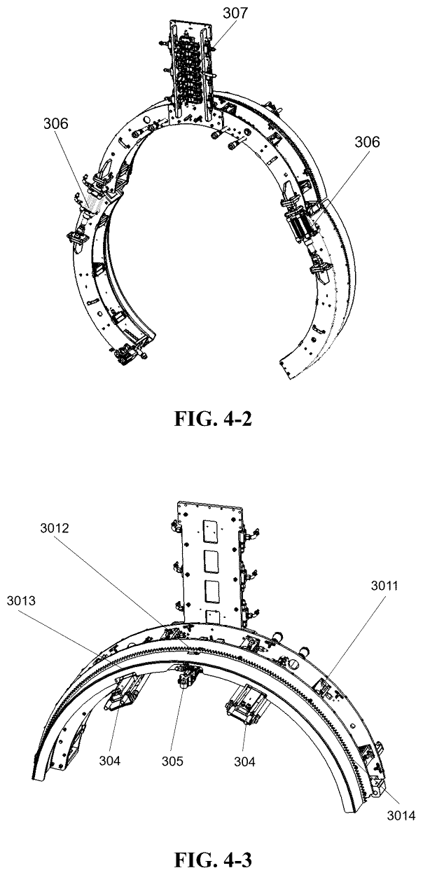

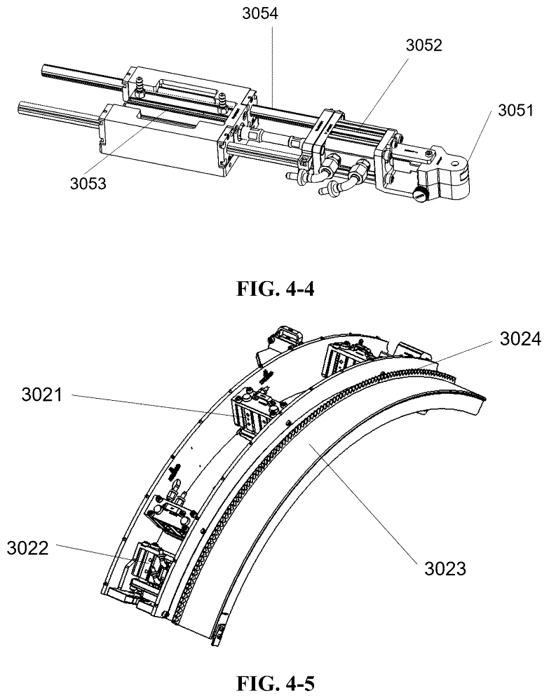

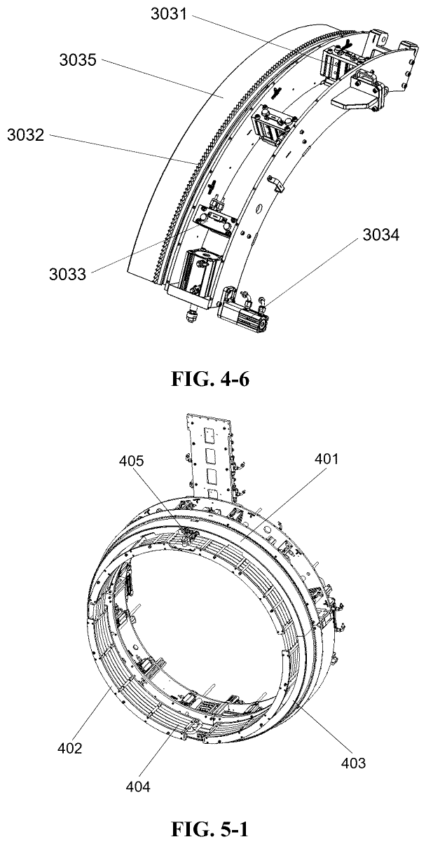

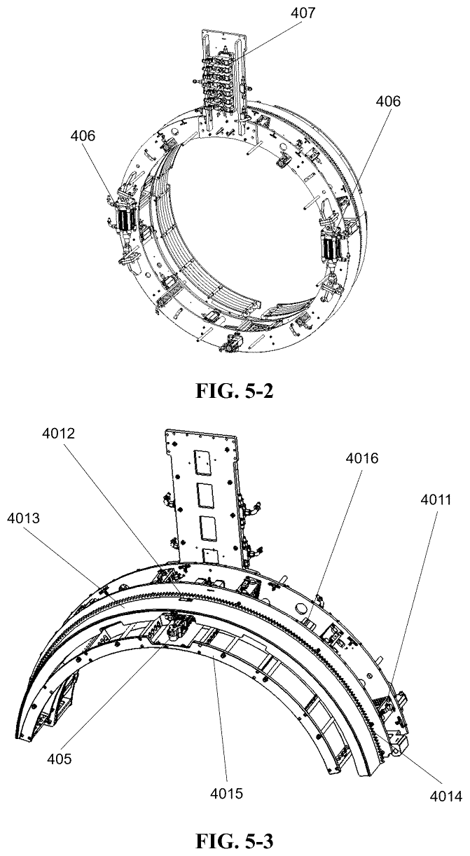

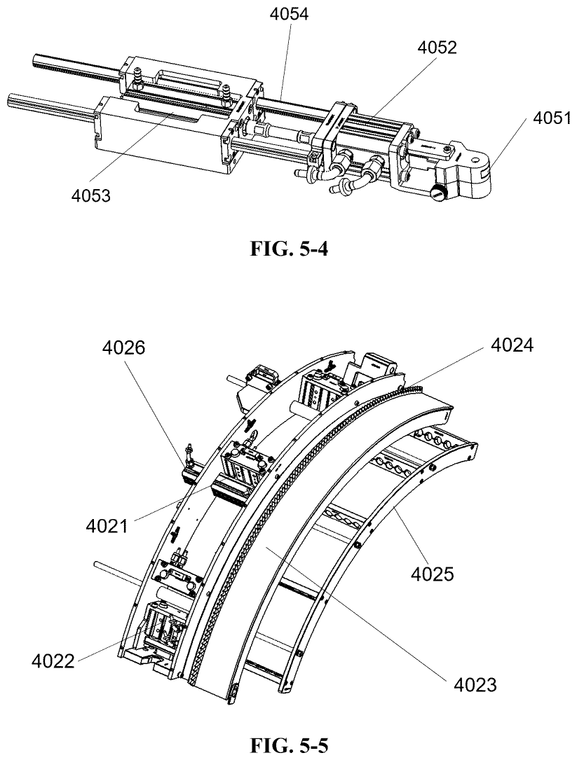

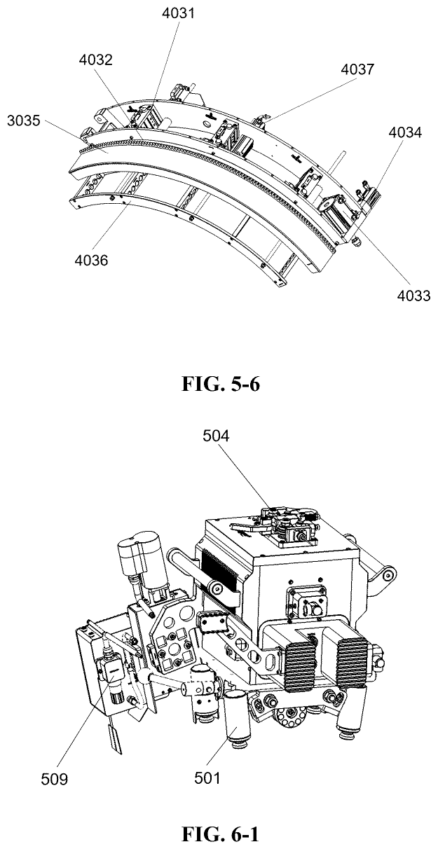

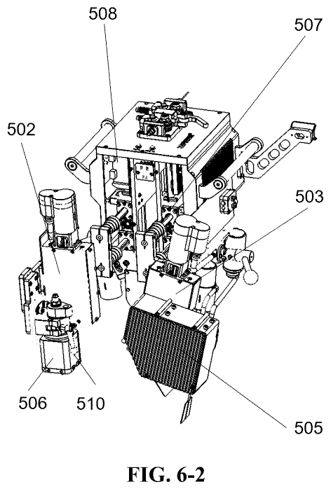

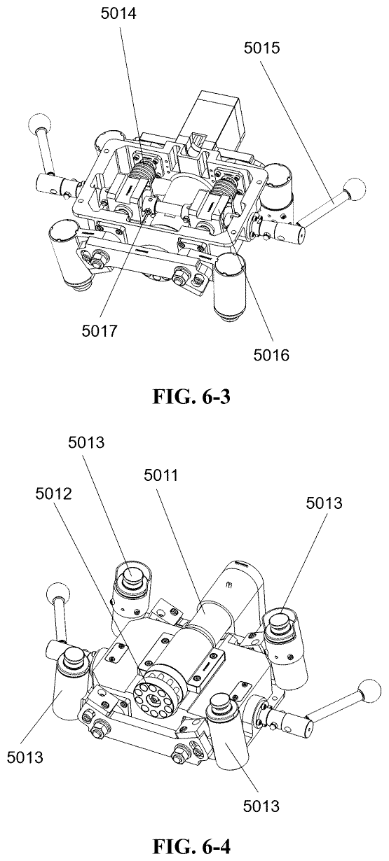

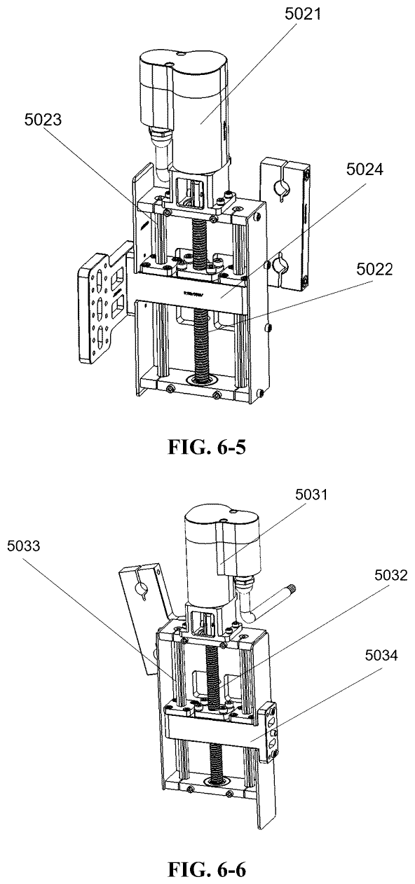

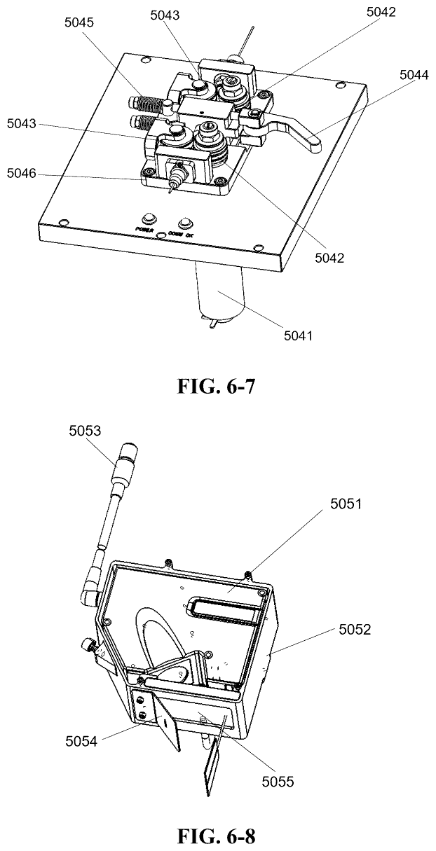

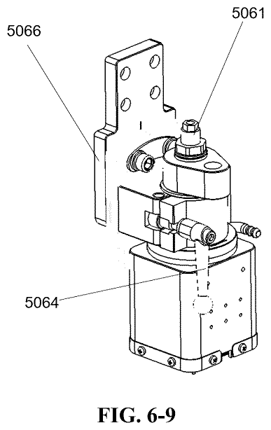

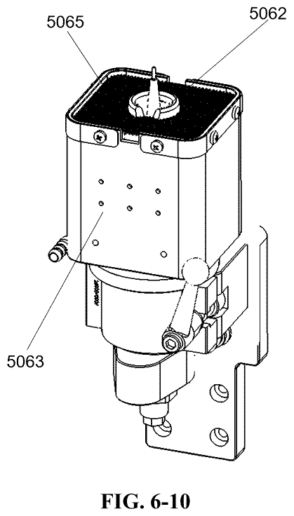

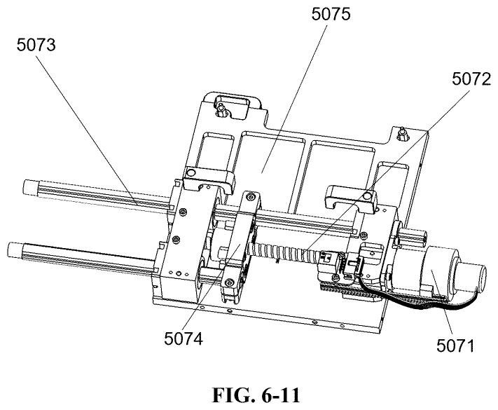

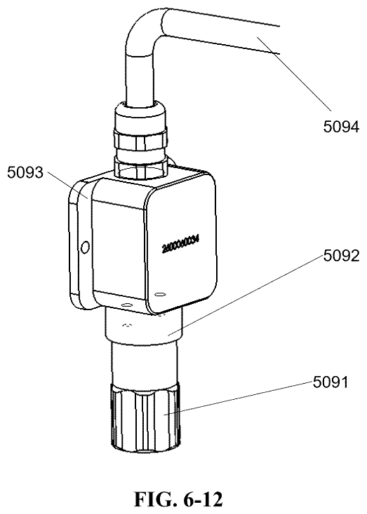

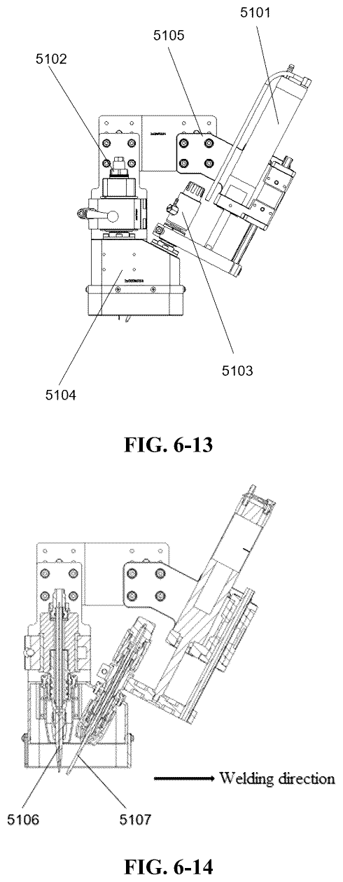

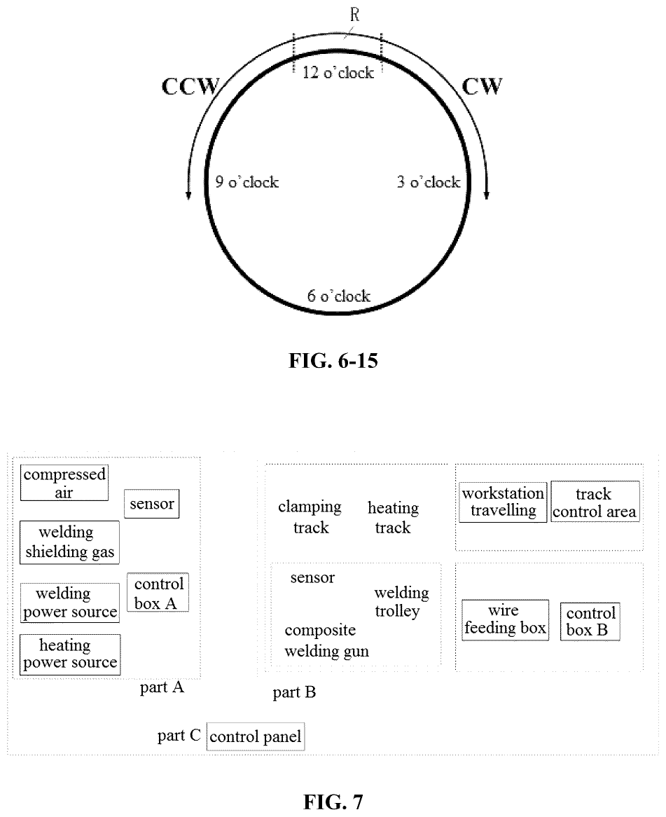

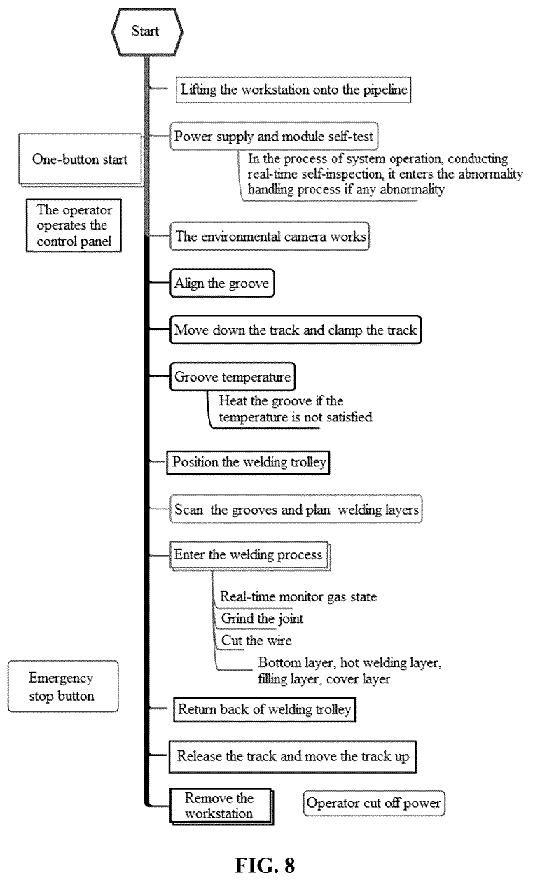

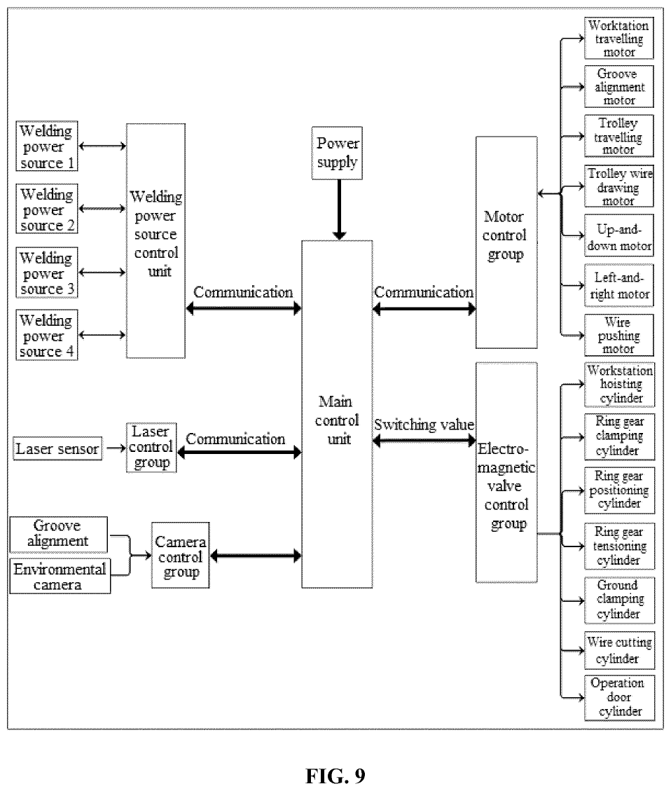

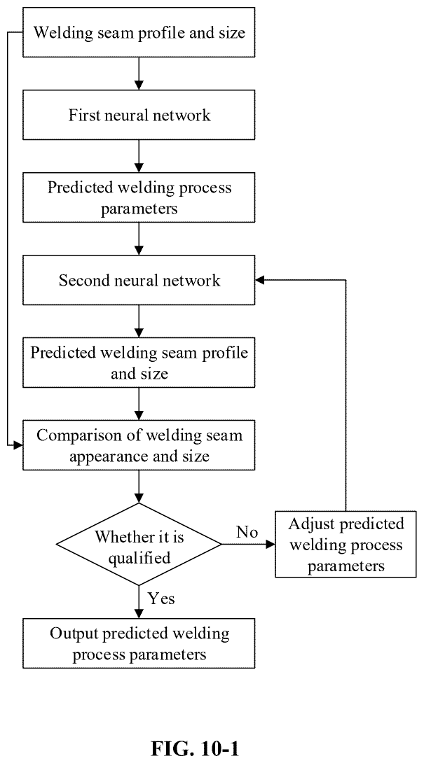

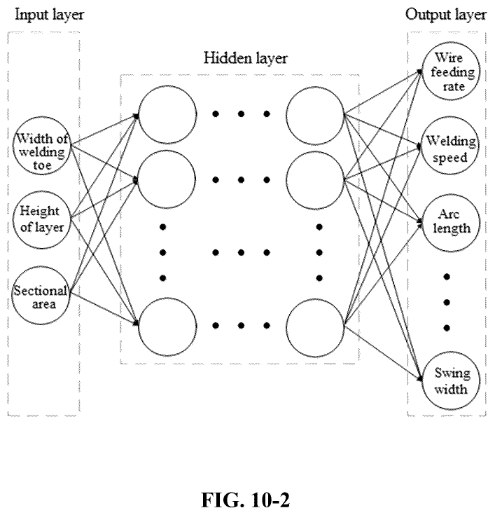

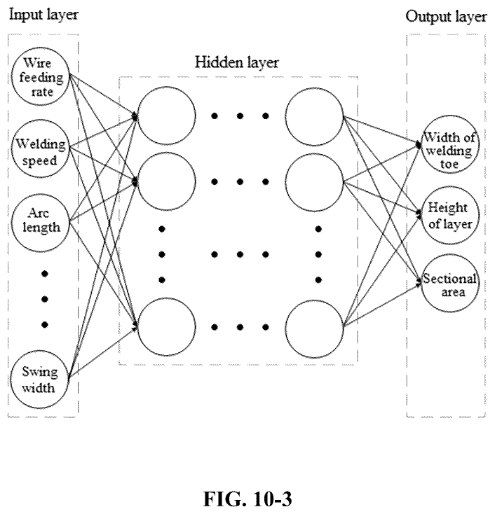

Referring to FIG. 1 to FIG. 10, FIG. 1 is a schematic structural diagram of a specific embodiment of a double track welding system provided by the present application; FIG. 2-1 is a schematic diagram of the structure of the leftward and rightward adjustment sliding table in the double track welding system shown in FIG. 1; FIG. 2-2 is another perspective of the structure of the leftward and rightward adjustment sliding table in the double track welding system shown in FIG. 1; FIG. 3-1 is a schematic structural diagram of the grinding mechanism in the double track welding system shown in FIG. 1; FIG. 3-2 is a schematic structural diagram from another perspective of the grinding mechanism in the double track welding system shown in FIG. 1; FIG. 3-3 is a schematic diagram of the transition of the grinding mechanism from the grinding working state to the grinding-completed working state in the double track welding system shown in FIG. 1; FIG. 3-4 is an enlarged schematic diagram of the grinding component in the grinding mechanism shown in FIG. 3-2; FIG. 3-5 is an enlarged schematic diagram of another perspective of the grinding component in the grinding mechanism shown in FIG. 3-2; FIG. 4-1 is a schematic structural diagram of the first track in the double track welding system shown in FIG. 1; FIG. 4-2 is a schematic structural diagram from another perspective of the first track in the double track welding system shown in FIG. 1; FIG. 4-3 is a schematic structural diagram of the first upper ring gear in the first track shown in FIG. 4-1; FIG. 4-4 is a schematic structural diagram of the first wire cutting mechanism in the first track shown in FIG. 4-1; FIG. 4-5 is a schematic structural diagram of the first left ring gear in the first track shown in FIG. 4-1; FIG. 4-6 is a schematic structural diagram of the first right ring gear in the first track shown in FIG. 4-1; FIG. 5-1 is a schematic structural diagram of the second track in the double track welding system shown in FIG. 1; FIG. 5-2 is a schematic structural diagram from another perspective of the second track in the double track welding system shown in FIG. 1; FIG. 5-3 is a schematic structural diagram of the second upper ring gear in the second track shown in FIG. 5-1; FIG. 5-4 is a schematic structural diagram of the second wire cutting mechanism in the second track shown in FIG. 5-1; FIG. 5-5 is a schematic structural diagram of the second left ring gear in the second track shown in FIG. 5-1; FIG. 5-6 is a schematic structural diagram of the second right ring gear in the second track shown in FIG. 5-1; FIG. 6-1 is a schematic structural diagram of the welding trolley in the double track welding system shown in FIG. 1; FIG. 6-2 is a schematic structural diagram from another perspective of the welding trolley in the double track welding system shown in FIG. 1; FIG. 6-3 is a schematic diagram of an internal structure of the travelling chassis in the welding trolley shown in FIG. 6-1; FIG. 6-4 is a schematic diagram of an overall structure of the travelling chassis in the welding trolley shown in FIG. 6-1; FIG. 6-5 is a schematic structural diagram of the welding torch upward and downward adjustment mechanism in the welding trolley shown in FIG. 6-1; FIG. 6-6 is a schematic structural diagram of the laser upward and downward adjustment mechanism in the welding trolley shown in FIG. 6-1; FIG. 6-7 is a schematic structural diagram of the wire drawing mechanism in the welding trolley shown in FIG. 6-1; FIG. 6-8 is a schematic structural diagram of the laser sensor in the welding trolley shown in FIG. 6-1; FIG. 6-9 is a schematic structural diagram of the welding torch in the welding trolley shown in FIG. 6-1; FIG. 6-10 is a schematic structural diagram of another perspective of the welding torch in the welding trolley shown in FIG. 6-1; FIG. 6-11 is a schematic structural diagram of the trolley leftward and rightward adjustment mechanism in the welding trolley shown in FIG. 6-1; FIG. 6-12 is a schematic structural diagram of the infrared temperature measuring mechanism in the welding trolley shown in FIG. 6-1; FIG. 6-13 is a schematic structural diagram of the composite welding gun in the welding trolley shown in FIG. 6-1; FIG. 6-14 is a cross-sectional view of the composite welding gun in the welding trolley shown in FIG. 6-1; FIG. 6-15 is a schematic diagram of the lap area in the weld bead of the groove; FIG. 7 is a block diagram of the “one-button operation” system in the double track welding system provided by the present application; FIG. 8 is a schematic flowchart of the “one-button operation” process in the double track welding system provided by the present application; FIG. 9 is a control structure diagram of the “one-button operation” system in the double track welding system provided by the present application; FIG. 10-1 is a schematic flowchart of a welding process parameter planning method in a double track welding system provided by the present application; FIG. 10-2 is a schematic diagram of the first neural network in the welding process parameter planning method shown in FIG. 10-1; FIG. 10-3 is a schematic diagram of the second neural network in the welding process parameter planning method shown in FIG. 10-1.

In this embodiment, the double track welding system includes:
a first track 300, the first track 300 is detachably mounted on a first side of the welding seam of the workpiece 600;
a second track 400, the second track 400 is detachably mounted on a second side of the welding seam of the workpiece 600; the workpiece 600 is exemplarily a pipeline, and the first track 300 and the second track 400 are exemplarily annular tracks;
a fixing bracket, the first track 300 and the second track 400 are both mounted on the fixing bracket, and the fixing bracket can drive the first track 300 and the second track 400 to move. Specifically, as shown in FIG. 1, the fixing bracket is U-shaped, the first track 300 and the second track 400 are respectively mounted on the ends of the two legs of the fixing bracket; the setting of the fixing bracket can realize the simultaneous movement of the first track 300 and the second track 400, which facilitates of hoisting;
multiple welding trolleys 500, each of the first track 300 and the second track 400 is provided with at least one the welding trolleys 500; the number of welding trolleys 500 can be set as required, such as two or more than three; the welding trolleys 500 on the first track 300 and the second track 400 can be moved clockwise and counterclockwise, respectively;
an image acquisition component 209 for acquiring image of part to be welded;
a welding seam scanning device for obtaining the shape of the welding seam;
a control system, which is configured to control the movement of the fixing bracket according to the image of the part to be welded, and the control system is further configured to determine preset welding process parameters according to the shape of the welding seam, and control the welding trolley 500 to weld the welding seam according to the preset welding process parameters. Specifically, as a control component of the entire dual gauge welding system, the control system can include a grinding control system 206 and a trolley control system 508.

On the basis of the above-mentioned embodiments, the double track welding system further includes a grinding mechanism 200, and the grinding mechanism 200 is mounted on the fixing bracket; the control system is configured to control the movement of the fixing bracket according to the image of the part to be welded, so that the grinding mechanism 200 corresponds to the position of the groove to be welded.

Further, the grinding mechanism 200 includes an image acquisition component 209 and a grinding laser sensor 205, the image acquisition component 209 is mounted on the fixing bracket, and the grinding laser sensor 205 is mounted on the grinding mechanism 200; the image acquisition component 209 is configured to acquire the image of the part to be welded, so as to be automatically aligned with the welding seam. The grinding laser sensor 205 is configured to identify the contour and position of the welding seam, so as to precisely grind the welding seam; the control system is further configured to control the action of the grinding mechanism 200 according to the contour and position of the welding seam.

Furthermore, the grinding mechanism 200 includes a grinding frontward and backward adjustment mechanism 201, a grinding leftward and rightward adjustment mechanism 202, a grinding upward and downward adjustment mechanism 203 and a grinding assembly 204. The control system can control the position of the grinding assembly 204 through the grinding frontward and backward adjustment mechanism 201, the grinding leftward and rightward adjustment mechanism 202, and the grinding upward and downward adjustment mechanism 203.

In a specific embodiment, the grinding mechanism 200 includes a grinding frontward and backward adjustment mechanism 201, a grinding leftward and rightward adjustment mechanism 202, a grinding upward and downward adjustment mechanism 203, a grinding assembly 204, a grinding laser sensor 205, a grinding control system 206, a grinding power 207, a grinding cylinder and an image acquisition component 209, the image acquisition component 209 is exemplarily a camera. The grinding frontward and backward adjustment mechanism 201, the grinding leftward and rightward adjustment mechanism 202 and the grinding upward and downward adjustment mechanism 203 are mainly composed of ball screws, motors and ball splines, which are mainly configured to control the grinding assembly 204 to move in the three coordinate directions of X-Y-Z. The grinding power 207 is configured as a grinding power 207 that provides power to the entire grinding control system 206. The grinding assembly 204 is mainly composed of a high-speed motor and a grinding disc or a milling disc, which is a direct component for grinding.

The grinding laser sensor 205 is mainly configured to scan the welding seam, identify the contour and precise position of the welding seam, and then control the movements of the grinding frontward and backward adjustment mechanism 201, the grinding leftward and rightward adjustment mechanism 202 and the grinding upward and downward adjustment mechanism 203 through the processing of the grinding control system 206. In this way, the grinding assembly 204 is precisely controlled to automatically grind the welding top lap position, so as to perform the function of automatically grinding the welding top lap position and ensure the high welding quality.

The image acquisition component 209 cooperates with the leftward and rightward adjustment sliding table 100 to perform precise control, so as to realize the automatic location and identification functions of the welding seam. In case that the leftward and rightward adjustment sliding table 100 is moved leftward and rightward, the image acquisition component 209 can appropriately scan and acquire the image of the area to be welded, and precisely determine the position of the groove to be welded through the image processing technology. Meanwhile, the moving position of the leftward and rightward adjustment sliding table 100 is controlled through the calculation of the grinding control system 206, so as to achieve the automatic positioning and identification function of the welding seam.

The grinding cylinder is configured for the upward and downward return of the grinding mechanism 200. When grinding is required, the grinding cylinder can control the grinding assembly 204 to rotate downwardly to be in place. When the grinding is completed, the grinding cylinder can control the grinding assembly 204 to rotate upwardly and return to its original position, so as to avoid interference with the welding trolley 500 and affect normal welding.

On the basis of the above-mentioned embodiments, the double track welding system further includes a leftward and rightward adjustment sliding table 100, which includes a sliding part and a fixing part. The sliding part is mounted on the fixing bracket and can drive the fixing bracket to move, and the fixing part is mounted on the workstation, which can be hoisted to the position where the workpiece 600 is, and then the fixing bracket can be moved to the target position through the leftward and rightward adjustment sliding table 100.

Further, the leftward and rightward adjustment sliding table 100 includes a sliding table sliding block 106, a sliding table linear sliding rail 103 and a sliding table cylinder 102, where the sliding table sliding block 106 is the sliding part of the leftward and rightward adjustment sliding table 100. The leftward and rightward adjustment sliding table 100 further includes a sliding table housing for mounting the sliding table sliding block 106, the sliding table linear sliding rail 103 and the sliding table cylinder 102. The sliding table housing is the fixing part of the leftward and rightward adjustment sliding table 100, and the sliding table sliding block 106 can be moved along the sliding table linear sliding rail 103. The sliding table cylinder 102 is mounted on the sliding table sliding block 106, and the grinding mechanism 200 is mounted on the sliding table cylinder 102; the control system is further configured to control the sliding table sliding block 106 to move according to the position of the welding seam.

In a specific embodiment, the leftward and rightward adjustment sliding table 100 includes a sliding table motor 101, a sliding table cylinder 102, a sliding table linear sliding rail 103, a sliding table ball screw 104, a sliding table travel switch 105, a sliding table sliding block 106 and a sliding table mounting bracket 107. When the leftward and rightward adjustment sliding table 100 is in operation on site, its fixing part is fixed on the top of the welding workstation; the leftward and rightward adjustment sliding table 100 controls the sliding table sliding block 106 to move leftward and rightward along the sliding table linear sliding rail 103 by the precise rotation of the sliding table motor 101 and the sliding table ball screw 104. The sliding table cylinder 102 is directly mounted on the sliding table sliding block 106, and the sliding table cylinder 102 is connected to the fixing bracket. The fixing bracket is configured to mount the grinding mechanism 200, the first track 300 and the second track 400, so as to control the leftward and rightward adjustment movement of the entire welding system, and then realize the automatic location and identification functions of the welding seam through the image acquisition and processing of the image acquisition component 209.

On the basis of the above-mentioned embodiments, the first track 300 and the second track 400 are both provided with a wire cutting mechanism; the control system is further configured to control the welding trolley 500 to move to the position of the wire cutting mechanism as receiving a wire cutting instruction, and control the wire cutting mechanism to perform a wire cutting action. Specifically, the wire cutting mechanism includes a blade, a wire cutting cylinder, an adjustment cylinder and a ball spline, where the adjustment cylinder is slideable on the ball spline, the wire cutting cylinder cab drive the action of the blade, and the control system completes the wire cutting action by controlling the adjustment cylinder and the wire cutting cylinder.

On the basis of the above-mentioned embodiments, the double track welding system further includes
a heating device, which is provided on one of the first track 300 and the second track 400;
a grounding device 304, which is provided on the other of the first track 300 and the second track 400;
a temperature collecting device for timely collecting the temperature of the part to be welded;
the control system is further configured to control the heating device to heat the part to be welded when the temperature of the part to be welded is lower than a preset temperature.

Further, the heating device is position-adjustably mounted on the first track 300 or the second track 400. The control system is configured to control the heating device to move to the welding seam for heating, and control the heating device to return back after the heating is completed. Specifically, when the temperature of the part to be welded is lower than the preset temperature, the heating device is controlled to heat the part to be welded. When the temperature of the part to be welded reaches the preset temperature, the heating device is controlled to return back.

It should be noted that, in the present application, taking the case that the grounding device 304 is set on the first track 300 and the heating device is set on the second track 400 as an example for illustration, that is, the first track 300 is configured as a ground track, and the second track 400 is configured as a heating track. Of course, the first track 300 can be configured as the heating track while the second track 400 can be configured as the grounding track. Setting the heating device and the grounding device 304 on different tracks can effectively prevent the heating device and the grounding device 304 from interfering with each other so as to meet the purpose for moving the heating device.

On the basis of the above-mentioned embodiments, the first track 300 and the second track 400 both include an upper ring gear, a left ring gear and a right ring gear. The left ring gear and the right ring gear are separable, and a clamping cylinder is provided between the left ring gear and the upper ring gear and between the right ring gear and the upper ring gear; the control system is further configured to control the extension and contraction of the clamping cylinder to disassemble or clamp the workpiece 600.

Further, both the first track 300 and the second track 400 are provided with tightening cylinders; the control system is configured to control the tightening cylinder to tighten the workpiece 600 after the first track 300 and the second track 400 are mounted in place.

In a specific embodiment, the first track 300 includes a first upper ring gear 301, a first left ring gear 302, a first right ring gear 303, a grounding device 304, a first wire cutting mechanism 305, a first clamping cylinder 306 and a first electromagnetic valve assembly 307. When the first clamping cylinder 306 is tightened, the first track 300 forms a closed-loop circular track, providing a fixed circular track for the welding trolley 500. When the first clamping cylinder 306 is extended, the first left ring gear 302 and the first right ring gear 303 are opened, so that the first track 300 can be moved upwardly and the workpiece 600 can be moved out easily. The first wire cutting mechanism 305 on the track is configured for automatic wire cutting of welding wire; the grounding device 304 is configured to connect the negative electrode of the welding power source and the workpiece 600 to form a welding circuit in order to realize the function of normal welding. The main function of the first electromagnetic valve assembly 307 is to control the actions of multiple cylinders on the track, so as to realize the actions of tightening, opening and closing the track. The first upper ring gear 301 includes a first upper jacking cylinder 3011, a first upward stroke switch 3012, a first upper travelling track 3013, a first upper ring gear body 3014, a grounding device 304 and a first wire cutting mechanism 305. The main function of the first upper jacking cylinder 3011 is to tighten the workpiece 600, so that the track is firmly fixed on the workpiece 600, so as to realize normal welding. The first wire cutting mechanism 305 includes a first blade, a first wire cutting cylinder, a first adjustment cylinder and a first ball spline. The automatic wire cutting function of welding wire is realized mainly by the first wire cutting mechanism 305, the first upward stroke switch 3012 with the calculation of the control system. When the welding trolley 500 on the first track 300 travels to the position of the first upward stroke switch 3012, the first upward stroke switch 3012 is triggered. In that case, the first adjustment cylinder is stretched out, and then the position of the welding torch 506 is precisely adjusted to be just above the orifice of the first blade with the calculation of the control system. Then the welding wire is moved down into the orifice of the first blade, the first wire cutting cylinder is activated to cut the welding wire, after completion, the welding torch 506 and the first adjustment cylinder are returned back, these actions are fully automated with the precise calculation of the control system.

The first left ring gear 302 includes a first left jacking cylinder 3021, a first left alignment cylinder 3022, a first left travelling track 3023 and a first left ring gear body 3024. The first left alignment cylinder 3022 is mainly configured to realize the positioning to the leftward and rightward ring gears by using the positioning rod in front of the first left alignment cylinder 3022 when the leftward and rightward ring gears are clamped, so as to ensure that the gap at the joint of the travelling tracks is not greater than 0.1 mm and ensure the stability of the welding trolley 500 when travelling. The main function of the first left jacking cylinder 3021 is to tighten the workpiece 600, so that the track is firmly fixed on the workpiece 600, so as to realize normal welding.

The first right ring gear 303 includes a first right jacking cylinder 3031, a first right ring gear body 3032, a first right clamping cylinder 3033, a first right positioning cylinder 3034 and a first right travelling track 3035. The first right clamping cylinder 3033 and the first right positioning cylinder 3034 are mainly configured for tensioning and positioning when the leftward and rightward ring gears are clamped. When the first right clamping cylinder 3033 is tightened, the first left ring gear 302 and the first right ring gear 303 can be merged together. Under the action of the first right clamping cylinder 3033, the leftward and rightward ring gears are clamped to form a closed-loop circular track while the first right positioning cylinder 3034 is extended out of the positioning pin to lock, preventing the leftward and rightward ring gears from expanding. The main function of the first right jacking cylinder 3031 is to tighten the workpiece 600, so that the track is firmly fixed on the workpiece 600 in order to realize normal welding.

The second track 400 includes a second upper ring gear 401, a second left ring gear, a second right ring gear 403, a heating device, a second wire cutting mechanism 405, a second clamping cylinder 406 and a second electromagnetic valve assembly 407. The heating device is exemplarily a heating coil 404. When the second clamping cylinder 406 is tightened, the second track 400 forms a closed-loop circular track, which provides a fixed circular track for the welding trolley 500. When the second clamping cylinder 406 is extended, the second left ring gear and the second right ring gear 403 are opened, so that the second track 400 can be moved upwardly and workpiece 600 can be moved out easily; the second wire cutting mechanism 405 on the second track 400 is configured for automatic wire cutting of welding wire; the heating coil 404 is configured for heating the workpiece 600 before welding, ensuring that the temperature of the workpiece 600 before welding meets the requirements of the welding process, in order to improve the welding quality. The main function of the second electromagnetic valve assembly 407 is to control the actions of multiple cylinders on the track, so as to realize the actions of tightening, opening and closing the track.

When the welding trolley 500 is moved along the track on the second track 400 and reaches the part to be welded, the temperature of the part to be welded is first collected by the infrared temperature measuring mechanism 509 in the welding trolley 500. When the temperature is lower than the preset temperature, the preset temperature is the appropriate welding working temperature, and the control system controls multiple heating coils 404 to adjust the cylinder being extended. Under the action of multiple heating coils 404 to adjust the cylinder, the heating coils 404 can extend to the welding seam area, and the control system can switch on the intermediate frequency heating power supply to heat the parts to be welded. During the heating process, the infrared temperature measuring mechanism 509 can timely collect the temperature of the part to be welded. After heating to the preset temperature, the control system cut off the intermediate frequency heating power supply to heat, and the heating coil 404 adjusts the cylinder to be retracted, and the heating coil 404 is retracted below the second track 400 so as not to affect the welding. With such a control method, the automatic temperature detection function before welding and during the welding process is realized, and the automatic heating function is realized with the automatic control.

The second upper ring gear 401 includes a second upper jacking cylinder 4011, a second upward stroke switch 4012, a second upper travelling track 4013, a second upper ring gear body 4014, an upper heating coil fixing bracket 4015, an upper heating coil push-out cylinder 4016 and a second wire cutting mechanism 405. The main function of the second upper jacking cylinder 4011 is to tighten the workpiece 600, so that the track is firmly fixed on the workpiece 600 in order to realize normal welding. The second wire cutting mechanism 405 includes a second blade 4051, a second wire cutting cylinder 4052, a second adjustment cylinder 4053 and a second ball spline 4054. The automatic wire cutting function of welding wire is realized mainly through the second wire cutting mechanism 405, the second upward stroke switch 4012 and the calculation of the control system. When the welding trolley 500 on the second track 400 is traveled to the position of the second upward stroke switch 4012, the second upward stroke switch 4012 is triggered. The second adjustment cylinder 4053 is extended out, and then the position of the welding torch 506 is precisely adjusted to be just above the orifice of the second blade 4051 through the calculation of the control system. Then the welding wire is moved downward and into the orifice of the second blade 4051, and the second wire cutting cylinder 4052 is activated to cut the welding wire. After completion, the welding torch 506 and the second adjustment cylinder 4053 are returned back, all these actions are fully automated through the precise calculation of the control system.

The upper heating coil fixing bracket 4015 is configured for fixing the heating coil 404, and the adjustment cylinder of the upper heating coil 404 is mainly configured for controlling the extension and retraction of the heating coil 404. When heating is required, the heating coil 404 can be extended to the weld area for heating under the action of multiple adjustment cylinders of the upper heating coil 404. After the heating is completed, the heating coil is returned under the second upper travelling track 4013 so as not to affect the welding.

The second left ring gear includes a second left jacking cylinder, a second left alignment cylinder, a second left travelling track, a second left ring gear body, a mounting bracket for the left heating coil 404 and an adjustment cylinder for the left heating coil 404. The second left alignment cylinder is mainly configured to realize the positioning to the leftward and rightward ring gears by using the positioning rod in front of the second left alignment cylinder when the leftward and rightward ring gears are clamped, so as to ensure that the gap at the joint of the travelling tracks is not greater than 0.1 mm and ensure the stability of the welding trolley 500 when travelling. The main function of the second left jacking cylinder is to tighten the workpiece 600, so that the track is firmly fixed left the workpiece 600, in order to realize normal welding. The second left heating coil fixing bracket is mainly configured for fixing the heating coil 404, and the adjustment cylinder of the left heating coil 404 is mainly configured for controlling the extension and retraction of the heating coil 404. When heating is required, the left heating coil 404 can be extended to the weld area for heating under the action of the adjustment cylinders of the left heating coil 404. After heating is completed, the left heating coil 404 can be retracted below the second left travelling track, so as not to affect the welding.

The second right ring gear 403 includes a second right jacking cylinder 4031, a second right ring gear body 4032, a second right clamping cylinder 4033, a second right positioning cylinder 4034, a second right travelling track 4035, a right heating coil fixing bracket 4036 and a right heating coil 404 adjustment cylinder 4037. The second right clamping cylinder 4033 and the second right positioning cylinder 4034 are mainly configured for tensioning and positioning when the leftward and rightward ring gears are clamped. When the second right clamping cylinder 4033 is tightened, the second left ring gear and the second right ring gear 403 can be merged together. Under the action of the second right clamping cylinder 4033, the leftward and rightward ring gears are clamped to form a closed-loop circular track while the second right positioning cylinder 4034 is extended out of the positioning pin to be locked, preventing the leftward and rightward ring gears from expanding; The main function of the second right jacking cylinder 4031 is to tighten the workpiece 600, so that the track is firmly fixed on the workpiece 600 in order to realize normal welding. The right heating coil fixing bracket 4036 is mainly configured for fixing the heating coil 404, and the adjustment cylinder 4037 of the right heating coil 404 is mainly configured for controlling the extension and retraction of the heating coil 404. When heating is required, the heating coil 404 can be extended to the weld area for heating under the action of the adjustment cylinders 4037 of the right heating coil 404. After heating is completed, the left heating coil 404 can be retracted under the second right travelling track 4035, so as not to affect the welding.

On the basis of the above-mentioned embodiments, the welding trolley 500 includes a travelling chassis 501, a composite welding gun 510, a welding torch 506 and a welding seam scanning device. The image acquisition component 209 further includes a trolley laser sensor 505, The composite welding gun 510, the welding torch 506 and the welding seam scanning device are all position-adjustably mounted on the travelling chassis 501; the control system is further configured to control the movement of the composite welding gun 510, the welding torch 506 and the welding seam scanning device. The welding seam scanning device is a trolley laser sensor 505, and at least one welding trolley 500 includes a welding seam scanning device. Specifically, the composite welding gun 510 includes a gas shielded welding gun 5102 and an argon arc welding gun 5103. The gas shielded welding gun 5102 is provided with a contact tip 5106, and the argon arc welding gun 5103 is equipped with a tungsten electrode 5107. The gas shielded welding gun 5102 is mainly configured for MAG welding process, and the argon arc welding gun 5103 is mainly configured for TIG welding process. During the composite welding process, the tungsten electrode 5107 of the argon arc welding gun 5103 is ahead, the contact tip 5106 of the gas shielded welding gun 5102 is in the rear. First, an arc molten pool is formed with the welding workpiece through the tungsten electrode 5107, and then the welding wire is inserted into the arc molten pool through the contact tip 5106. With this welding method, the lap position of the welding is relatively smooth, and a grinding-free welding process can be realized. Further, the composite welding gun 510 further includes a welding gun cylinder 4501, a welding gun protective cover 5104 and a related welding gun mounting bracket 5105; the welding gun protective cover 5104 is located outside the contact tip 5106 and the tungsten electrode 5107 of the gas shielded welding gun 5102 and the argon arc welding gun 5103. The welding gun cylinder 4501 is configured to control the extension and retraction of the argon arc welding gun 5103, thereby realizing the advance and retreat of the argon arc welding gun 5103.

The composite welding gun 510 can perform the grinding-free welding method of multi-layer and multi-pass welding, and the welding method adopts a composite groove. After the pre-welding preparation and root welding are completed, argon arc welding gun 5103 performs non-filler welding for a certain length on both sides of the 12 o'clock position of the blunt edge under the set welding parameters, and then performs clockwise and counterclockwise welding on the hot welding layer, filling layer and cover layer. The composite welding gun is configured to control arc starting in sections by adopting a combination of TIG welding and MAG welding in the arc starting lap region R of each weld pass, and then MAG welding is carried out for subsequent welding. Compared with the existing pipeline all-position automatic welding method, the welding arc-starting method with combination of TIG welding and MAG welding effectively solves the problem that the lap position needs to be polished, and thus greatly improves the welding efficiency of pipeline all-position automatic welding with high degree of automation and being more environment-friendly.

Further, the welding trolley 500 further includes a welding torch upward and downward adjustment mechanism 502 for adjusting the position of the welding torch 506, a laser upward and downward adjustment mechanism 503 for adjusting the position of the trolley laser sensor 505, a trolley leftward and rightward adjustment mechanism 507 for adjusting the left-and-right position of the welding trolley 500, a wire drawing mechanism 504 for conveying welding wires, and a temperature measuring mechanism for monitoring the temperature of the workpiece 600 before welding. The temperature measuring mechanism is exemplarily an infrared temperature measuring mechanism 509, the control system is in communication connection with the welding torch upward and downward adjustment mechanism 502, the laser upward and downward adjustment mechanism 503, the trolley leftward and rightward adjustment mechanism 507 and the temperature measuring mechanism.

In a specific embodiment, the welding trolley 500 includes a travelling chassis 501, a welding torch upward and downward adjustment mechanism 502, a laser upward and downward adjustment mechanism 503, a wire drawing mechanism 504, a trolley laser sensor 505, a welding torch 506, a trolley leftward and rightward adjustment mechanism 507, a trolley control system 508 and an infrared temperature measuring mechanism 509.

The travelling chassis 501 includes a trolley travelling motor 5011, a trolley driving wheel 5012, a trolley driven wheel 5013, a trolley spring 5014, a trolley handle 5015, a trolley travelling sliding block 5016 and a trolley cam 5017. The travelling chassis 501 adopts the working principle of cam, and is equipped with two cam groups. When the trolley handle 5015 is rotated, the two cam groups and the trolley handle 5015 rotate synchronously. When the cam rotates, the cam groups can apply a force to the trolley travelling sliding block 5016, and thus the two groups of trolley springs 5014 are compressed as the trolley travelling sliding block 5016 slides toward the motor. The four trolley driven wheels 5013 generate clamping force under the force of the spring, so that the welding trolley 500 can be fixed on the track. The welding torch upward and downward adjustment mechanism 502 includes a welding gun motor 5021, a welding gun ball screw 5022, a welding gun ball spline 5023 and a welding gun sliding block 5024; the welding torch upward and downward adjustment mechanism 502 mainly controls the speed of the welding gun ball screw 5022 through precise controlling to the speed of the welding gun motor 5021, so as to control the frontward and backward positions of the nut of the welding gun ball screw 5022. The nut of the welding gun ball screw 5022 is fixed and integrated with the welding gun sliding block 5024. When the nut of the welding gun ball screw 5022 moves back and forth, the welding gun sliding block 5024 also moves synchronously, and the welding gun ball spline 5023 mainly performs a function of positioning, so as to precisely control the upper and lower positions of the welding gun.

The laser upward and downward adjustment mechanism 503 mainly controls the speed of the laser ball screw 5032 through precise control of the speed of the laser motor 5031, so as to control the frontward and backward positions of the nut of the laser ball screw 5032. The nut of the laser ball screw 5032 is fixed and integrated with the laser sliding block 5034. When the nut of the laser ball screw 5032 moves back and forth, the laser sliding block 5034 also moves synchronously, and the laser ball spline 5033 mainly performs a function of positioning, so as to precisely control the upper and lower positions of the laser device.

The wire drawing mechanism 504 includes a wire drawing motor 5041, a wire drawing driving wheel 5042, a wire pressing wheel 5043, a wire drawing adjustment handle 5044, a wire drawing spring 5045 and an insulating pad 5046. The wire drawing motor 5041, the wire drawing driving wheel 5042, the wire pressing wheel 5043, the wire drawing adjustment handle 5044 and the wire drawing spring 5045 are all mounted on the insulating pad 5046, and the insulating pad 5046 is mounted on the wire drawing main body. When welding is required, the welding wire is passed through the middle position between the wire drawing driving wheel 5042 and the wire pressing wheel 5043, and the lateral force of the wire pressing wheel 5043 causes the welding wire to generate friction with the wire drawing driving wheel 5042. Also, the wire drawing driving wheel 5042 has a groove in V-shape, and the rotation speed of the wire drawing driving wheel 5042 can be precisely controlled by controlling the rotation speed of the wire drawing motor 5041. As such, the friction force between the wire drawing driving wheel 5042 and the welding wire drives the welding wire to be moved forward to achieve the welding wire feeding function. When the wire drawing mechanism 504 is not required to be in operation, the wire pressing wheel 5043 can be disengaged from the wire drawing driving wheel 5042 by adjusting the angular position of the wire drawing adjustment handle 5044. The working principle of the wire drawing adjustment handle 5044 mainly adopts the working principle of cam, and the compression degree of the wire drawing spring 5045 is adjusted by adjusting the angle of the wire drawing adjustment handle 5044, so that the working state and the non-working state can be converted, and the operation is very simple.

The trolley laser sensor 505 includes a laser sensor body 5051, a mounting box body 5052, a laser control line 5053, a slag baffle 5054 and a transparent plate 5055. The laser sensor body 5051 is located in the mounting box body 5052, and the laser control wire 5053 is led out from the laser sensor body 5051. The transparent plate 5055 is located on one side of the mounting box body 5052, and the slag baffle 5054 is located on the outer side of the transparent plate 5055. The slag baffle 5054 can be opened to expose the transparent plate 5055, which facilitates for the laser sensor body 5051 to collect the welding seam profile; the trolley laser sensor 505 is mainly configured to scan the area to be welded. The trolley laser sensor 505 scans the part to be welded, and sends the scanning result to the control system. The control system calculates and adapts the dynamic scheme of welding process parameters according to the shape and position of each portion of the part to be welded. According to the dynamic scheme, the parts to be welded are welded, and the position of the welding torch 506 is adjusted in real time to automatically track the welding torch 506. Meanwhile, the dynamic scheme realizes the automatic planning of multi-layer and multi-pass welding as well as the function of automatic design of all-position welding process parameters.

The welding torch 506 includes a welding gun assembly 5061, a nozzle 5062, a protective cover 5063, a welding torch handle 5064, a copper mesh 5065 and a welding torch mounting bracket 5066. The welding gun assembly 5061 is located on the welding torch mounting bracket 5066, the nozzle 5062 is located inside the protective cover 5063. The welding torch handle 5064 is configured to fasten the welding gun assembly 5061, and the copper mesh 5065 is aimed to block the influence of the splash during the welding process on the inside of the welding torch 506. The welding torch 506 mainly uses the high current and high voltage of the welding power source to gather the heat at the welding torch terminal, melt the welding wire, and the melted welding wire penetrates into the part to be welded. After cooling, the welded objects are firmly connected into a whole. The main function of the nozzle 5062 is to provide welding shielding gas to the molten pool, and the protective cover 5063 provides welding shielding gas around the molten pool, thus forming a double-layer shielding gas area to ensure high-quality welding.

The trolley leftward and rightward adjustment mechanism 507 includes a trolley leftward and rightward adjustment motor 5071, a trolley ball screw 5072, a trolley ball spline 5073, a trolley leftward and rightward adjustment sliding block 5074 and a trolley mounting bracket 5075. The trolley leftward and rightward adjustment mechanism 507 mainly controls the rotation speed of the trolley ball screw 5072 by precisely controlling the rotation speed of the trolley leftward and rightward adjustment motor 5071, thereby controlling the frontward and backward positions of the nuts of the trolley ball screw 5072. The nut of the trolley ball screw 5072 and the trolley leftward and rightward adjustment sliding block 5074 are fixed integrally while the trolley ball spline 5073 and the trolley leftward and rightward adjustment sliding block 5074 are fixed and integrated. When the nut of the trolley ball screw 5072 is moves back and forth, the trolley ball spline 5073 also moves synchronously, thus realizing the precise control of the leftward and rightward positions of the laser device and the welding gun.

The infrared temperature measuring mechanism 509 includes a protective cover 5091, a temperature sensor 5092, a temperature measuring mounting bracket 5093 and an infrared control line 5094; the infrared temperature measuring mechanism 509 mainly adopts the infrared temperature sensor 5092. The infrared temperature sensor 5092 makes use of the radiation thermal effect, which causes the temperature of the detector to rise after receiving radiation energy, and then changes the performance of the infrared temperature sensor 5092. The temperature sensor 5092 is mainly configured to measure the temperature of the workpiece 600 before welding to ensure high quality of welding.

The double track welding system can comprehensively reduce the hard work of long-distance pipeline welding operators and solve the talent bottleneck that no one is willing to learn welding; in addition, the double track welding system can open the technical barriers to enter the world oil and natural gas long-distance pipeline construction market products, and occupy the technical commanding heights of intelligent long-distance pipeline welding equipment products.

The double track welding system has the function of automatic temperature detection before welding and during welding, and realizes automatic heating through automatic control; when the welding trolley 500 moves along the track on the heating track and reaches the part to be welded, the temperature of the part to be welded is first collected by the infrared temperature measuring mechanism 509 on the welding trolley 500. When the temperature is lower than the preset temperature, the control system controls multiple heating coils 404 to adjust the cylinder to be extended. Under the adjustment of heating coils 404 to the cylinder, the heating coils 404 can be extended to the welding seam area and the control system switches on the intermediate frequency heating power supply to heat the parts to be welded. During the heating process, the infrared temperature measuring mechanism 509 can timely collect the temperature of the part to be welded. After reaching the preset temperature by heating, the heating of the intermediate frequency heating power supply stops, the heating coil 404 adjusts the cylinder so as to be retracted, and the heating coil 404 is retracted to be below the heating track so as not to affect the welding; With this control method, the automatic temperature detection function before welding and during the welding process is realized, and the automatic heating function is realized through automatic control.

The double track welding system is highly intelligent, and uses one-button operation to complete all welding processes. As shown in FIG. 7, the “one-button operation” welding system includes three parts: A, B and C. Part A is the welding energy module, including a welding power source, a heating power source, a welding shielding gas, a compressed air, a control box A and a gas flow sensor, where the welding power source provides welding energy to control the arc, and the heating power source provides groove heating energy, and the gas flow sensor is designed to measure the welding shielding gas in real time, ensuring the reliability of the welding process and achieving the functions of prediction and alarm in advance.

Part B is the workstation execution module, including a welding trolley 500, a wire feeding box, a control box B, a clamping track, a heating track, sensor, a track control area, and a workstation travelling, where the welding trolley 500 includes a welding gun upward and downward adjustment structure, a trolley leftward and rightward adjustment mechanism 507, and a laser upward and downward adjustment mechanism 503; wire feeding control, that is, controlling the wire feeding box to feed wire for the wire drawing mechanism 504; the clamping track controls the ring gear used to close the first track 300 or the second track 400 to clamp the workpiece 600; the heating track is configured for controlling the heating device in the first track 300 or the second track 400 to heat the position of the welding seam; the track control area includes the control to the electromagnetic valve assembly and the input and output control;

part C is the operation panel, which provides the human-computer interaction module for equipment operators and maintenance personnel; the operation panel and control system adopt wireless transmission to ensure the operability and convenience on site.

The double track welding system adopts the “one-button operation” process, as shown in FIG. 8. In order to reduce the operator's labor intensity and improve the welding quality, a “one-button operation” welding system is adopted, which aims to obtain the intelligentialization of the equipment and reduces human intervention. Starting from the lifting of the workstation to the pipeline to be welded, the power supply is started, and the control system performs self-inspection to each module or assembly. During the operation of the system, self-check is performed in real time. If there is any abnormality, a warning prompt is given on the operation panel, and the equipment is put into the abnormal handling process until the equipment is normal.

When the operator clicks a button for “one-button start”, the double track welding system automatically calls the preset modules and processes, that is, the control system executes control operations in sequence after receiving the one-button start instruction. The control operation includes the following steps:
step S1: controlling the operation of each module of the system, including the real-time monitoring and display of the environment in the workstation by the environment camera, and then start the process of automatic groove alignment. By means of the coordination and calculation of the travelling module, that is, the leftward and rightward adjustment sliding table 100, the image acquisition component 209, the laser control module and the main control unit, the automatic groove alignment is achieved. The environment camera is mounted in the protective casing of the workstation, and the double track welding system is position-adjustably mounted inside the protective casing;
step S2: clamping the first track 300 and the second track 400 inside the workstation to ensure the fastening between the track and the pipeline workpiece and there is no relative motion there between. It can ensure the reliability of welding only if the tracks remain stable;
step S3: an infrared temperature measuring mechanism 509 is mounted on the welding trolley 500, which can detect the temperature of the groove before welding and the interlayer temperature during the welding process to ensure the quality of welding;
step S4: scanning the groove, when the welding trolley 500 is mounted on the corresponding track for the first time, it is necessary to position the welding trolley 500 and determine an absolute initial zero position, which is very important to the trajectory planning and anti-collision algorithm of multiple welding trolleys 500 on the track; a trolley laser sensor 505 is mounted on the welding trolley 500. Before welding, the welding seam needs to be pre-scanned according to the trajectory so as to identify the characteristics of the welding seam. Then, the calculation of the control system in the control box is carried out to obtain the most suitable welding process parameters of the unwelded groove of the current layer and the number of welding layers of the groove, that is, planning the welding layer. Then, after the welding trolley 500 returns to the starting point, welding is performed according to the current welding process parameters of the current layer. After this welding is completed, the execution is repeated. In the next welding, the welding process parameters calculated last time is fine-tuned until the welding of the entire groove is completed; the welding includes welding of primer layer, thermal welding layer, filling layer and cover layer.
step S5: moving the workstation away; after welding, it is necessary to move multiple welding trolleys 500 to a safe position, then loosen the ring gears of the first track 300 and the second track 400, and move the ring gears upward to a safe position in the workstation; use the on-site pipelayer to lift the workstation away from the pipeline, and perform the “one-button operation” welding process to the next groove according to the construction sequence.

As shown in FIG. 9, in the control structure diagram of “one-button operation” system, the control system adopts the all-digital control technology platform with the programmable logic device of ARM architecture as the core. The main chip is a fully integrated hybrid processor solution, which can exert high processing power in various applications, the main chip can further have the perfect integration of programmable video processing capabilities and a highly integrated peripheral group, the control precision is high, the operation is flexible, and abundant peripheral resources are available, such as LCD (liquid crystal display), HDMI interface, camera, USB interface, IIC integrated circuit bus, UART transceiver, SPI interface, SATA hard disk, PCIE capture card, CAN bus, Ethernet, GPMC interface, etc., and the scalability is strong. The entire system can be software-reconfigured and upgraded without changing the hardware system.

The control system includes a main control unit, a motor control group, an electromagnetic valve control group, a welding power source control unit, a laser control group, a camera control group and a gas protection control unit. The main control unit is linked with the motor control group, the welding power source control unit, the laser control group and the camera control group in communication in order to ensure system stability and avoid interference to the greatest extent possible. All input and output signals are designed with photoelectric isolation.

Specifically, the main control unit is mainly responsible for the logic control and data coordination of the system. There is a corresponding control unit to output the switching value and control the electromagnetic valve control group of the entire system, including information related to the workstation hoisting mechanism, the ring gear mechanism, the grounding clamping mechanism, the wire cutting mechanism and the door-to-door operation.

The motor control group includes the driver of the sub-function modules and motor assembly, and the motor control group is linked to the main control unit in communication. Each motor in the motor assembly is responsible for communicating with the driver of each sub-function module. The main control unit can control multi-axis motors in real time with high precision and high speed. The main control unit calculates the positions of all motors in software to prevent maloperation or collision of motors. The motor assembly includes a workstation travelling motor, a groove alignment motor, a trolley travelling motor, a trolley wire drawing motor 5041, an up-and-down motors, a left-and-right motors and wire pushing motor. The workstation travelling motor is the motor used to move the entire workstation, and the groove alignment motor is the sliding table motor 101 in the leftward and rightward adjustment sliding table 100. The trolley travelling motor is the trolley travelling motor 5011 in the travelling chassis 501, the trolley wire drawing motor 5041 is the wire drawing motor 5041 in the wire drawing mechanism 504. The up-and-down motor includes the motors in the grinding upward and downward adjustment mechanism 203, the welding torch upward and downward adjustment mechanism 502 and the laser upward and downward adjustment mechanism 503. The left-and-right motors include the motors in the grinding leftward and rightward adjustment mechanism 202 and the trolley leftward and rightward adjustment mechanism 507, and the wire pushing motor is the motor in the wire feeding box.

The welding power source control unit is responsible for the information conversion between the main control unit and the welding power source 1-4. The information includes welding process parameters, such as welding voltage, wire feeding rate, welding gun travelling speed, welding gun swing width, welding gun swing frequency, welding gun leftward and rightward residence time, welding gun switch signal and heartbeat signal. All parameters are transmitted transparently in real time to achieve the communication between the main control unit and the welding power source.

The laser control group is responsible for the data transmission between the laser control system, the laser sensor and the main control unit. The laser sensor includes a trolley laser sensor and a grinding laser sensor. Calculate the original data, and then communicate the geometric dimensions and key information of the welding groove with the main control unit for processing by the main control unit.

The camera control group includes two parts: a groove alignment and an environmental photography. The groove alignment means that when the workstation travels to the groove to be welded, an image acquisition component 209, such as a camera, is configured to acquire the image of the groove. Then, the control unit in the camera control group performs data processing to obtain the precise groove position. The travelling and calculation of the workstation are processed in real time, so that the workstation is automatically aligned with the groove and stays right above the groove within an error range; the environmental photography refers to the real-time display of the internal environment for the system workstation through the environmental camera. When holding the operation panel, the operator can check the working conditions inside the workstation, and the environmental camera provides the operator with the intuitive effect of all components inside the workstation.

The power supply provides a stable power supply for the whole system. The control unit is powered by DC 34-38V, the solenoid valve assembly unit is powered by DC 22-26V, and the workstation travelling motor unit is powered by DC 46-50V. The system adopts different voltage power supply according to different applications, so that the system can achieve the optimal power supply effect.

The double track welding system has the function of multi-layer and multi-channel automatic planning, which automatically designs all-position welding process parameters. Specifically, the pipeline welding process planning method includes:
step S1: scanning the welding seam;
step S2: extracting the actual welding seam profile of the welding seam and the coordinates of its key points;
step S3: determining whether the current scan is a pre-scan, if so, go to step S6, if not, go to step S4;
step S4: determining whether the actual welding seam profile conforms to the planned welding seam profile, and when the actual welding seam profile conforms to the planned welding seam profile, go to step S5;
step S5: determining whether the actual welding seam profile is the welding seam profile of the last capping layer, and if so, end the welding; if not, go to step S7;
step S6: determining the number of welding layers and welding beads according to the actual welding profile, and determining the planned welding profile of each welding seam in each layer;
step S7: determining the welding process parameters corresponding to each welding seam and each layer according to the profile of the planned welding seam;
step S8: determining the motion trajectory of the welding gun according to the planned welding seam profile and welding process parameters;
step S9: controlling the welding gun to weld the welding seam according to the welding process parameters and the motion trajectory;
step S10: after the welding is completed, return to step S1.

Further, as shown in FIG. 10-1, step S7 includes,
step S7-1: obtain the predicted welding process parameters through the first neural network according to the planned welding seam profile;
step S7-2: obtain the predicted welding seam profile through the second neural network according to the predicted welding process parameters;
step S7-3: determine whether the predicted welding seam profile is qualified relative to the planned welding seam profile, if yes, output the predicted welding process parameters obtained in step S7-1, if not, return to step S7-2 after adjusting the predicted welding process parameters. Specifically, when comparing the predicted welding seam profile with the planned welding seam profile, the dimensions of each element of the welding seam profile are compared, and a precision range can be set. When the predicted welding seam profile does not exceed the precision range of the planned welding seam profile, it is determined as being qualified. The planned welding seam profile and the predicted welding seam profile include the weld toe width, cross-sectional area and layer height of the current layer to be welded; the predicted welding process parameters include wire feeding rate, welding speed, arc length and swing width.

Specifically, both the first neural network and the second neural network include an input layer, a hidden layer and an output layer. The input layer of the first neural network has the same parameters with the output layer of the second neural network, and the output layer of the first neural network has the same parameters with the input layer of the second neural network.

In a specific embodiment, according to the planned welding seam profile, the weld toe width, cross-sectional area and layer height of the current layer to be welded are input into the welding process parameter planning module. First, through the first neural network, as shown in FIG. 10-2, the predicted welding process parameters, which is need to be used to reach the pre-planned welding seam profile, are predicted. The predicted welding process parameters include wire feeding rate, welding speed, arc length and swing width, etc. Because the output parameters of the first neural network are more than the input parameters, and the precision of prediction is poor, it is necessary to input the predicted welding process parameters into the second neural network, as shown in FIG. 10-3, to carry out of reversing the welding seam profile to obtain the preset welding seam profile. Next, the planned welding seam profile is compared with the predicted welding seam profile, and if the precision requirements are satisfied, the welding process parameters predicted by the first neural network are directly output; if the precision requirement is not satisfied, the welding process parameters are properly adjusted, re-input into the second neural network for prediction and comparison, and the predicted welding process parameters are output until the precision requirement is satisfied.

The double track welding system also has the function of automatic wire cutting:
the automatic wire cutting function of welding wire is mainly realized by the wire cutting mechanism, the first upward stroke switch 3012/the second upward stroke switch 4012 with the calculation of the control system. When the welding trolley 500 travels along the first track 300 or the second track 400 to the position of the first upward stroke switch 3012/the second upward stroke switch 4012, the first upward stroke switch 3012/the second upward stroke switch 4012 can be triggered, and the first adjustment cylinder/the second adjustment cylinder 4053 are extended out. Then the position of the welding torch 506 is precisely adjusted to be just above the orifice position of the first blade/second blade 4051 with the calculation of the control system, and then the welding wire is moved down into the orifice of the first blade/second blade 4051. The first wire cutting cylinder/second wire cutting cylinder 4052 are activated to cut the welding wire. After completion, the welding torch 506 and the first adjustment cylinder/second adjustment cylinder 4053 are returned back. These actions are fully automated through the precise calculation of the control system.

The double track welding system provided by the present disclosure includes a first track 300 and a second track 400 clamped on both sides of the part to be welded, and a control system. Each track is provided with at least one welding torch 506 that can be moved along the track, at least one track is provided with a temperature collecting device, at least one track is provided with a heating device, at least one track is provided with a welding seam scanning device capable of moving along the track. First, the temperature of the part to be welded is collected by the temperature collecting device, when the temperature is lower than the preset temperature, the pipeline heating device is configured to heat the part to be welded to the preset temperature, then the part to be welded is scanned by the welding seam scanning device, and the scanning result is sent to the control system. The control system adapts the dynamic scheme of welding process parameters according to the shape and position of each part of the part to be welded, and the welding torch 506 welds the part to be welded according to the dynamic scheme. The welding method includes that the welding torches 506 are working together to complete the first layer welding, and the welding torches 506 are carrying out a relay welding to complete the welding of different layers, respectively.

The double track welding system provided by the present disclosure can effectively improve the welding efficiency through the arrangement of at least two tracks. Meanwhile, the image of the part to be welded and the profile of the welding seam are collected by the image acquisition component 209, and then the automatic identification, automatic planning and automatic welding of the welding seam are realized by the control system, which improves the degree of automation, effectively reduces the labor intensity, and improves the welding precision.

The above embodiments are described in a progressive manner. Each of the embodiments is mainly focused on describing its differences from other embodiments, and reference may be made among these embodiments with respect to the same or similar parts.

The double track welding system according to the present disclosure is described in detail hereinbefore. The principle and embodiments of the present disclosure are described through specific examples herein. The description of the above-described embodiments is merely used to facilitate understanding the method and core idea of the present application. It should be noted that, for those skilled in the art, many modifications and improvements may be made to the present disclosure without departing from the principle of the present application, and these modifications and improvements are also deemed to fall into the protection scope of the present disclosure defined by the claims.

1. A double track welding system, comprising:
a first track, which is detachably mounted on a first side of a welding seam of a workpiece;
a second track, which is detachably mounted on a second side of the welding seam of the workpiece;
a fixing bracket, wherein the first track and the second track are both mounted on the fixing bracket, and the fixing bracket is able to drive the first track and the second track to move;
a plurality of welding trolleys, each of the first track and the second track is provided with at least one the plurality of welding trolleys;
an image acquisition component for acquiring an image of a part to be welded;
a welding seam scanning device for obtaining a profile of the welding seam; and
a control system, wherein the control system is configured to control a movement of the fixing bracket according to the image of the part to be welded, the control system is further configured to determine preset welding process parameters according to the profile of the welding seam and control the plurality of welding trolleys to weld the welding seam according to the preset welding process parameters.

2. The double track welding system according to claim 1, further comprising a grinding mechanism, wherein the grinding mechanism is mounted on the fixing bracket, the control system is configured to control the movement of the fixing bracket according to the image of the part to be welded so that the grinding mechanism is moved so as to correspond to a position of a groove to be welded.

3. The double track welding system according to claim 2, wherein the grinding mechanism comprises an image acquisition component and a grinding laser sensor, the image acquisition component is mounted on the fixing bracket, and the grinding laser sensor is mounted on the grinding mechanism,
the grinding laser sensor is configured to identify the profile and the position of the welding seam, the control system is further configured to control an action of the grinding mechanism according to the profile and the position of the welding seam; wherein the grinding mechanism further comprises a grinding frontward and backward adjustment mechanism, a grinding leftward and rightward adjustment mechanism, a grinding upward and downward adjustment mechanism and a grinding assembly, the control system controls a position of the grinding assembly by the grinding frontward and backward adjustment mechanism, the grinding leftward and rightward adjustment mechanism, and the grinding upward and downward adjustment mechanism.

4. The double track welding system according to claim 2, further comprising a leftward and rightward adjustment sliding table, wherein the leftward and rightward adjustment sliding table comprises a sliding part and a fixing part, the sliding part is mounted on the fixing bracket and is able to drive the fixing bracket to move, and the fixing part is mounted on the workstation,
the leftward and rightward adjustment sliding table comprises a sliding table sliding block, a sliding table linear sliding rail and a sliding table cylinder, the sliding table sliding block is moveable along the sliding table linear sliding rail, the sliding table cylinder is mounted on the sliding table sliding block, and the grinding mechanism is mounted on the sliding table cylinder,
the control system is further configured for controlling the sliding table sliding block to move according to the position of the welding seam.

5. The double track welding system according to claim 1, wherein the first track and the second track are both provided with a wire cutting mechanism, wherein the control system is further configured to control the plurality of welding trolleys to move to a position of the wire cutting mechanism when receiving a wire cutting instruction, and control the wire cutting mechanism to perform a wire cutting action.

6. The double track welding system according to claim 5, wherein the control system executes control operations in sequence after receiving an one-button start instruction.

7. The double track welding system according to claim 1, further comprising:
a heating device, which is provided on one of the first track and the second track;
a grounding device, which is provided on the other of the first track and the second track; and
a temperature collecting device for timely acquiring the temperature of the part to be welded, wherein
the control system is further configured to control the heating device so as to heat the part to be welded when the temperature of the part to be welded is lower than a preset temperature.

8. The double track welding system according to claim 7, wherein the heating device is position-adjustably mounted on the first track or the second track, the control system is configured to control the heating device to move to the welding seam for heating, and control the heating device to return back after the heating is completed.

9. The double track welding system according to claim 1, wherein the first track and the second track both comprise an upper ring gear, a left ring gear and a right ring gear, wherein the left ring gear and the right ring gear are separable, and clamping cylinders are provided between the left ring gear and the upper ring gear and between the right ring gear and the upper ring gear, respectively,
the control system is further configured to control an extension and a retraction of the clamping cylinder to disassemble or clamp the workpiece, both the first track and the second track are provided with tightening cylinders, the control system is configured for controlling the tightening cylinders to tighten the workpiece after the first track and the second track are mounted in place.

10. The double track welding system according to claim 1, wherein each of the plurality of welding trolleys comprises a travelling chassis, a composite welding gun, a welding torch and the welding seam scanning device, the image acquisition component further comprises a trolley laser sensor, wherein the composite welding gun, the welding torch and the welding seam scanning device are all position-adjustably mounted on the travelling chassis, and the composite welding gun comprises a gas shielded welding gun and an argon arc welding gun,
the control system is further configured to control a movement of the composite welding gun, the welding torch and the welding seam scanning device.

11. The double track welding system according to claim 10, wherein the gas shielded welding gun is configured to implement a MAG welding process, and the argon arc welding gun is configured to implement a TIG welding process,
the composite welding gun is configured to control an arc starting in sections by adopting a combination of the TIG welding and the MAG welding in the arc starting lap region R of each weld pass, and then MAG welding is implemented for subsequent welding.

12. The double track welding system according to claim 10, wherein each of the plurality of welding trolleys further comprises:
a welding torch upward and downward adjustment mechanism for adjusting a position of the welding torch;
a laser upward and downward adjustment mechanism for adjusting a position of the trolley laser sensor;
a trolley leftward and rightward adjustment mechanism for adjusting a left-and-right position of each welding trolley;
a wire drawing mechanism for conveying a welding wire; and
a temperature measuring mechanism for monitoring a temperature of the workpiece before welding, wherein
the control system is communication-linked with the welding torch upward and downward adjustment mechanism, the laser upward and downward adjustment mechanism, the trolley leftward and rightward adjustment mechanism and the temperature measuring mechanism.
